(19) United States
(12) Patent Application Publication
(10) Pub. No.: US 2025/0360970 A1
(43) Pub. Date: Nov. 27, 2025

(54) Cab Mounting System And Method For Controlling The Cab Mounting System

(71) Applicant: ZF Friedrichshafen AG, Friedrichshafen (DE)

(72) Inventors: Manuel Behner, Lenggries (DE); Alfred Memmel, Schonungen (DE); Matthias Virnekäs, Breitbrunn (DE)

(73) Assignee: ZF Friedrichshafen AG, Friedrichshafen (DE)

(21) Appl. No.: 18/872,563

(22) PCT Filed: Jun. 5, 2023
(86) PCT No.: PCT/EP2023/064920

§ 371 Date: Dec. 6, 2024

(30) Foreign Application Priority Data
Jun. 9, 2022 (DE) 10 2022 205 861.5

(51) Int. Cl. B62D 33/06

(52) U.S. Cl. CPC B62D 33/0608

(57) ABSTRACT

A cab mount (25) for a vehicle (1) has a cab (5) separate from a vehicle frame (3). The cab is mounted so as to be levelable with respect to a vehicle standing surface by means of at least three adjustable actuators (7-13), and a levelness adjusted by the actuators is blockable at least when the vehicle is stationary. The cab mount has at least one stabilizer (27) for supporting roll movements of the cab during driving operation. The stabilizer has at least two switching steps with different spring rates, and the stabilizer has the higher of the at least two spring rates in stationary operation of the vehicle when the cab is leveled.

### PRIORITY CLAIM

This is a U.S. national stage of application No. PCT/EP2023/064920filed on Jun. 5, 2023. Priority is claimed on German, Application No.: 10 2022 205 861.5, filed Jun. 9, 2022; the content of which is incorporated here by reference.

### BACKGROUND OF THE INVENTION

### 1. Field of the Invention

The invention is directed to a cab mount according to the preamble of patent claim 1.

### 2. Description of the Related Art

EP 1 584 545 B1 describes a cab mount for a utility vehicle in which the cab mount is, inter alia, optimized for comfort when the vehicle is stationary. The goal is for the cab to be level when the vehicle is stationary and for the position to be maintained also during external excitation of the vehicle. A wind impact resulting from a passing vehicle is mentioned as an example of an external excitation. Air springs with variable volume are used for leveling.

The horizontal attitude of the cab is achieved by means of adjustable air springs which can be filled individually. Adjustable vibration dampers which are adjusted to a hard damping force setting serve to fix the adjusted horizontal attitude of the cab. Additionally, a mechanical locking of the vehicle cab can also be provided. Further, the cab mount has a passive stabilizer which is configured for the driving operation of the utility vehicle.

Modern adjustable vibration dampers are configured such that a comfortable damping force setting is linked with low energy use of an actuator for the at least one adjustable damping valve. It has been shown that most driving is done in the comfort range of the vibration damper and a hard damping force setting is only necessary in critical driving situations. The advantage of combining low damping force with low actuator energy results in low energy use. However, when the vibration damper is utilized to block the cab, the actuator must be permanently fed as electric consumer when the vehicle is stationary.

A further disadvantage in supporting the cab by means of adjustable vibration dampers is that only a low damping force is achieved during a low-frequency excitation in spite of a hard damping force setting. This operating behavior is desirable in a vibration damper in keeping with its designated function. The desired stabilizing effect may not be achieved under some circumstances within the framework of an aimed for blocking function.

### SUMMARY OF THE INVENTION

It is an object of the present invention to realize a cab mount and a control for a cab mount in which the drawbacks known from the prior art are at least minimized.

The above-stated object is met in that the stabilizer has at least two switching steps with different spring rates and the stabilizer has the higher of the at least two spring rates in stationary operation of the vehicle when the cab is leveled.

A great advantage of the invention consists in that a very good stabilization of the cab can be achieved with the stabilizer. Further, a gain in comfort is achieved for the driving operation by means of the adjustable stabilizer. In this regard, the stabilizer can be actively operated, i.e., the stabilizer can generate a variable bending moment via an energy input, or the stabilizer is switchable, e.g., mechanically, via a coupling.

In an operating position, the stabilizer is preferably switched to no power with respect to the cab in order to carry out the leveling of the cab with as little energy input as possible.

The actuators preferably have a supporting stop in each instance which supports the cab when the actuator is deactivated. The supporting stop can be formed, e.g., by a vibration damper which is connected in parallel with the actuator. Alternatively, the actuator can have a buffer stop, e.g., as air spring, so that the air spring bellows of the air spring is protected.

Additionally, it can be provided that the vehicle frame supporting the cab is operatively connected, at least indirectly, to selectively activatable supports. Many vehicles have an air suspension at least at the front axle which could be vented for stabilization of the vehicle frame. The air springs would have to be filled again with the necessary air mass before continuing driving. In case of a support that is separately indirectly connected to the frame, only the travel of the support between the supporting position and driving position would have to be carried out as energy input.

Particularly vehicles which are used for long distance travel and for which the function of leveling represents a key comfort feature for the driver have a so-called swap body system in which the vehicle body can be uncoupled from the vehicle and parked until the start of a new trip. In principle, this vehicle body has supports via which the vehicle frame can be fixed with respect to the vehicle supporting surface. The springiness of the vehicle frame can be indirectly prevented in this way. Crane vehicles or transporters for skips also have frame-side supports which can be utilized for support during pauses in driving for stabilizing the cab.

Further, the solution to the above-stated object includes a method in which the instantaneous angular orientation of the cab is detected and the stabilizer is adjusted to its minimum spring rate, the supporting force of the actuators is reduced until one of the actuators has a minimum supporting length because of the load of the cab, and the cab is aligned horizontal to a reference plane via actuation of the further actuators when this supporting length of the one actuator is reached, the cab being secured in the horizontal operating position via the adjustment of the stabilizer to a maximum spring rate.

The entire method can be carried out in its entirety with a low energy input. The absolute distance to the vehicle frame or to the supporting surface of the vehicle is negligible for purposes of leveling the cab. The lower support point first reached by all of the actuators, particularly air springs, forms the support point for the entire plane to be adjusted when leveling.

As an additional measure for stabilizing, it is provided that the supports fix the vehicle on the frame side before the alignment of the cab has begun.

Further, in a vehicle with adjustable suspension, an adjustment of the suspension for assisting in the leveling of the cab can be carried out. The adjusting range for the leveling can be appreciably increased in this way. A preemption is useful for the actuators of the cab mount in order to optimize energy input because the cab is lighter than the vehicle in its entirety or even than one half of the vehicle.

### BRIEF DESCRIPTION OF THE DRAWINGS

The invention will be described in more detail referring to the following description of the drawings.

The drawings show:

FIG. 1 a schematic diagram of a vehicle cab;

FIG. 2 detail view of a cab mount according to FIG. 1;

FIG. 3 actuator according to FIG. 2 in section;

FIG. 4 vehicle according to FIG. 1 with supports; and

FIG. 5 circuit diagram referring to FIG. 1.

### DETAILED DESCRIPTION OF THE DISCLOSED EMBODIMENTS

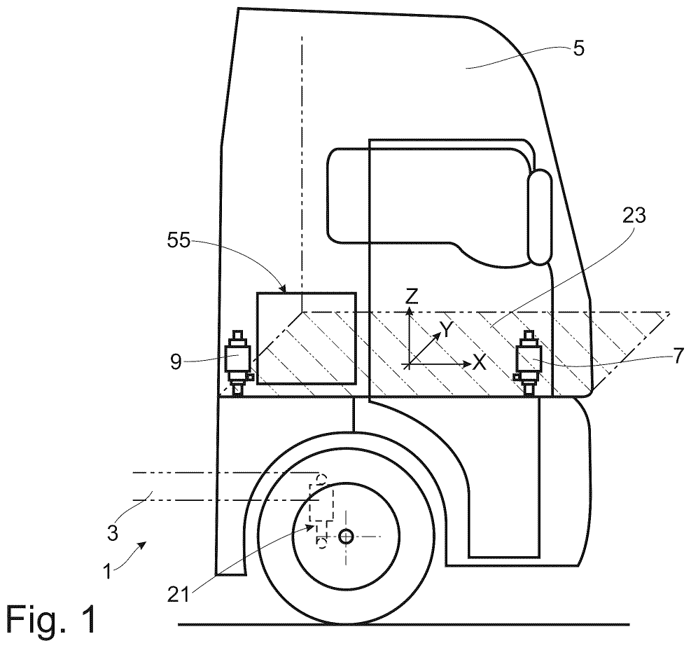

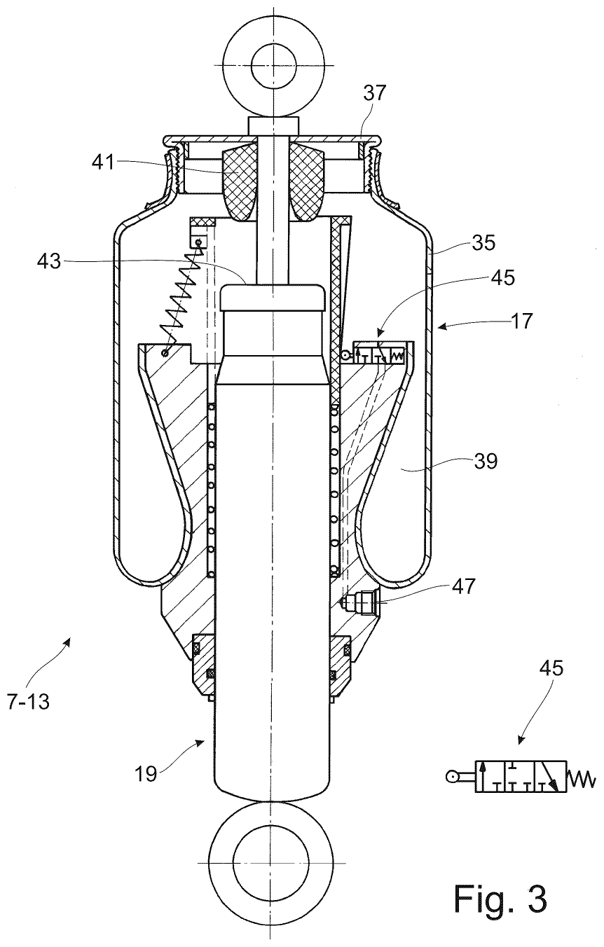

FIG. 1 is a highly simplified depiction of a utility vehicle 1 with a cab 5 separate from a vehicle frame 3. The cab 5 is mounted so as to be levelable with respect to a vehicle standing surface 15 by means of at least three adjustable actuators 7-13. The actuators 7-13 are preferably formed as air springs 17 in combination with a vibration damper 19. Such an actuator, shown by way of example in FIG. 3, is known from DE 102 00 553 C1. The vehicle frame 3 is in turn supported on a supporting surface via supporting elements as component part of a chassis, not shown in more detail. In principle, the supporting elements 21 can be constructed identical to the actuators, possibly adapted to a higher load.

In driving operation, the actuators 7-13 serve to support the cab 3 with the aim of maintaining as far as possible a level attitude, e.g., while cornering or during braking processes. The cab 3 is often also outfitted with a rest region in which a plane 23 which is as horizontal as possible is aimed for particularly when a vehicle is stationary for a longer period of time. The rest region is to be stably supported, i.e., free from vibrations caused by external excitation. This plane is shown in diagonal shading in FIG. 1.

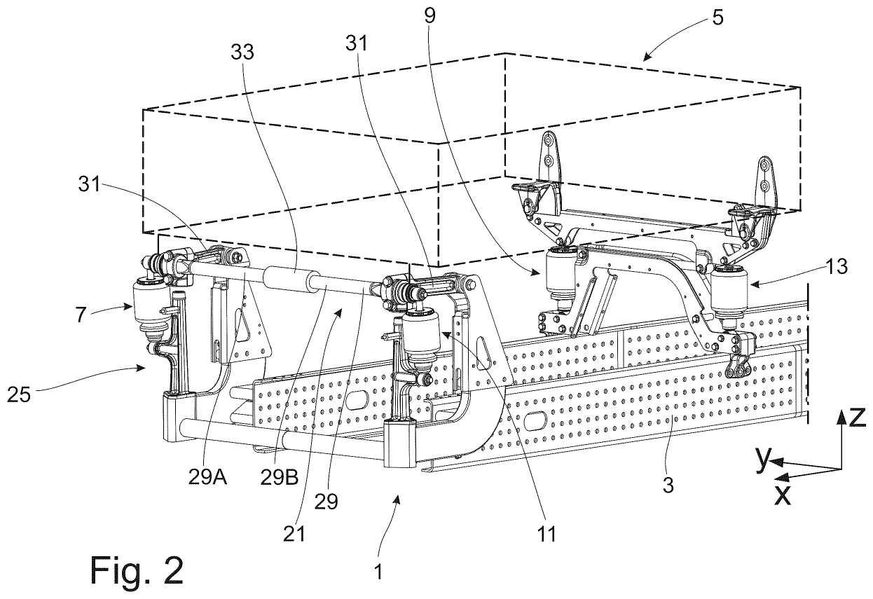

In addition to the actuators 7-13, a cab mount 25 has at least one stabilizer 27 (see FIG. 2) for supporting roll movements of the cab 5 during driving operation. The stabilizer 27 in this case is constructed as a torsion rod 29 with two angled bending bars 31. The bending bars 31 are supported at least indirectly at the vehicle frame 3. In this illustration, the torsion rod comprises two parts, a switchable coupling 33 being arranged between rod portions 29A; 29B. Accordingly, the stabilizer has at least two switching steps with different spring rates. A spring rate can be, e.g., 0 Nm/° when the coupling is open and a second spring rate corresponds to the passive spring rate of the stabilizer when the coupling is closed. The coupling may be constructed as a switchable connecting element between the two rod portions 29A; 29B. However, a swing motor which is connected to an energy generating system, e.g., a hydraulic system, by means of which an actuating torque can be actively introduced to the cab 5 can also be provided.

Alternatively, a conventional torsion rod with a switchable bending bar, e.g., with a hydraulic piston-cylinder unit which can be constructed in turn as a passive element with a switchable blocking valve or, as active element, as a hydraulic cylinder, can be used instead of a partitioned torsion rod 29.

Regardless of the design of the stabilizer 27, this stabilizer 27 has at least two spring rates, e.g., a low spring rate with open coupling 33 and a high spring rate with closed coupling. Of course, intermediate settings are also possible with a swing motor or a hydraulic cylinder.

Additionally, it is provided that the stabilizer 27 has the higher of the at least two spring rates during stationary operation of the vehicle 1 when the cab 5 is level. Accordingly, the stabilizer 27 provides for a sufficient stabilization of the cab against external influences, such as crosswind when the vehicle is stationary. No particular energy input is needed for adjusting the higher spring rate. Accordingly, e.g., with a swing motor, the connection to the hydraulic system can be blocked by a valve.

To adjust the horizontal attitude of the cab 5, the stabilizer 27 is switched to no power with respect to the cab. When the retaining force of the actuators 7-13 is canceled, the cab 5 can drop due to its inherent weight without the stabilizer 27 building up a relevant counterforce.

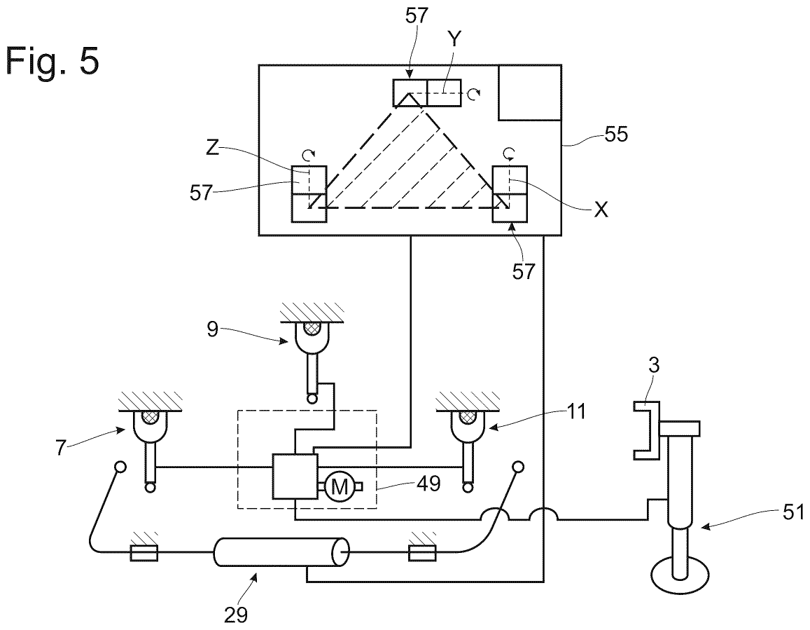

FIG. 3 shows one of the actuators 7-13 in an exemplary configuration. A buffer stop is arranged as supporting stop 41 inside of a spring space 39 which is bounded by a rolling lobe 35 and a cover 37 and contacts an end face 43 of the vibration damper 19 at minimum supporting length of the actuator 7-13. Accordingly, the supporting stop 49 supports the cab 5 when the actuator is deactivated. In this actuator 7-13, the valving 45 required for the operation of the actuator is a component part of the actuator, although this type of construction is not a compulsory requirement for the use of the invention. Also apparent is the connection 47 of the actuator to an active pressure medium supply system 49, e.g., a compressed air supply, for the air spring 17 (see FIG. 5).

As has already been disclosed, the chassis can also be outfitted with such an actuator so that the chassis and, therefore, the entire vehicle body can also be stabilized.

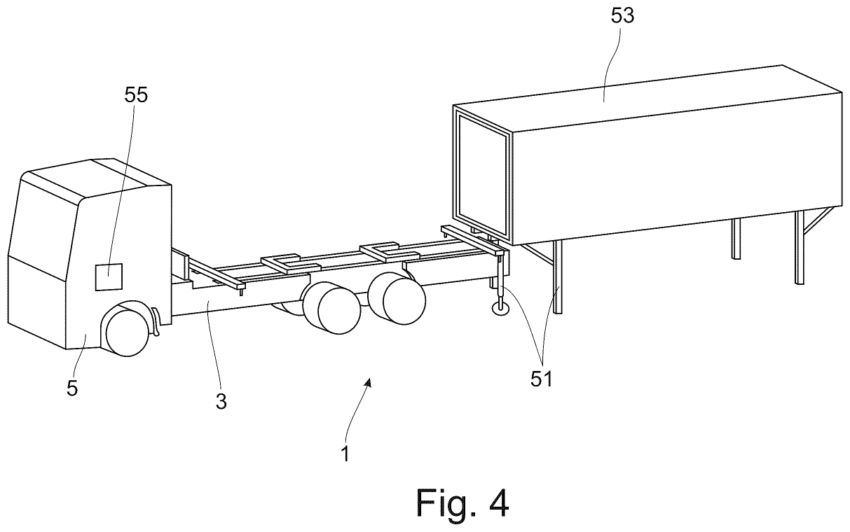

FIG. 4 schematically shows the entire vehicle 1. If the vehicle is not to be stabilized via the chassis, the vehicle frame 3 can be operatively connected at least indirectly to selectively activatable supports 51. Alternatively, the supports 51 can also be a component part of a vehicle body 53. In a vehicle with an exchangeable body, supports 51 are provided as a matter of principle. The supporting function of the supports 51 of the vehicle body is transferred to the entire vehicle via the connection between the vehicle body 53 and the vehicle frame 3.

FIG. 5 shows the connection of a control device 55 for implementing a method for controlling the cab mount 25. The control device 55 processes signals which describe the absolute instantaneous orientation of the cab 5, i.e., isolated from the supporting surface and the frame position. To this end, e.g., three separate position sensors 57 can be used, e.g., acceleration sensors, displacement sensors or angle sensors. The sensors can be component parts of the control device 55 or a component part of the actuator 7-13. A gyroscopic sensor which can provide all three angular signals is also contemplated.

The instantaneous angular orientation of the cab 5 is detected when the leveling of the cab 5 is initiated for the stationary state of the vehicle. The stabilizer 27 is adjusted to its minimum spring rate. The supporting force of the actuators 7-13 is reduced until a horizontal attitude of the cab 5 is achieved. Thereafter, the supporting force for all of the actuators 7-13 is reduced until one of the actuators has a minimum supporting length due to the load of the cab 5, i.e., the supporting stop 41 is active. By leveling beforehand, it is ensured that no larger amounts of energy need be supplied for leveling the cab. When this supporting length of the one actuator, e.g., actuator 7, is achieved, it is exactly oriented horizontal to a reference plane via the actuation of the further actuators 9-13. The cab 5 is then secured in this leveled operating position via the adjustment of the stabilizer 27 to a maximum spring rate.

It can be provided in addition that the supports 51 fix the vehicle 1 on the frame side before the alignment of the cab 5 has begun. In this way, a stable initial situation is produced for implementing the method. In principle, the supports could also be inserted after the leveling of the cab. When lowering, the orientation of the frame to the supporting surface could also change and could, therefore, also change the spring forces within the chassis. In a vehicle with an adjustable air suspension in the vehicle, a chassis condition would be occupied which would have to be corrected again when driving is resumed because the cab 5 is then raised somewhat again in order to have a spring travel available within the cab mount. This control process is dispensed with in case of a timely blocking of the vehicle frame 3.

Under extreme boundary conditions, e.g., when the vehicle supporting surface is so steep that the adjusting range of the actuators 7-13 of the cab mount 25 is not sufficient for leveling, an adjustment of the suspension can be carried out in a vehicle with adjustable supporting elements 21 for assisting in the leveling of the cab 5.

1. A cab mount for a vehicle with a cab separate from a vehicle frame, wherein the cab is mounted so as to be levelable with respect to a vehicle standing surface by at least three adjustable actuators, and a levelness adjusted by the actuators is blockable at least when the vehicle is stationary, wherein the cab mount has at least one stabilizer for supporting roll movements of the cab during driving operation, wherein the stabilizer has at least two switching steps with different spring rates and the stabilizer has the higher of the at least two spring rates in stationary operation of the vehicle when the cab s leveled.

2. The cab mount according to claim 1, wherein stabilizer is switched to no power with respect to the cab in an operating position.

3. The cab mount according to claim 1, wherein the actuators have a supporting stop in each instance which supports the cab when the actuators are deactivated.

4. The cab mount according to claim 1, wherein the vehicle frame is operatively connected, at least indirectly, to selectively activatable supports.

5. The cab mount according to claim 4, wherein the supports are a component part of a vehicle body.

6. A method for controlling the cab mount according to claim 1, wherein the instantaneous angular orientation of the cab is detected and the stabilizer is adjusted to its minimum spring rate, wherein the supporting force of the actuators is reduced until one of the actuators has a minimum supporting length due to the load of the cab, and the cab is aligned horizontal to a reference plane via actuation of the further actuators when this supporting length of the one actuator is reached, wherein the cab is secured in the horizontal operating position via the adjustment of the stabilizer to a maximum spring rate.

7. The method according to claim 6, wherein the supports fix the vehicle on the frame side before the alignment of the cab has begun.

8. The method according to claim 6, wherein in a vehicle with adjustable suspension, an adjustment of the suspension is carried out for assisting in the leveling of the cab.
